(19) United States
(12) Patent Application Publication
(10) Pub. No.: US 2020/0147768 A1
(43) Pub. Date: May 14, 2020

(54) CAPTIVE FASTENER

(71) Applicant: Katerra Inc., Menlo Park, CA (US)

(72) Inventors: Darrin Griechen, Spokane, WA (US); Robert Stanford, Flowery Branch, GA (US)

(73) Assignee: Katerra Inc., Menlo Park, CA (US)

(21) Appl. No.: 16/682,682

(22) Filed: Nov. 13, 2019

Related U.S. Application Data
(60) Provisional application No. 62/760,533, filed on Nov. 13, 2018.

(51) Int. Cl. B25B 23/08

(52) U.S. Cl. CPC B25B 23/08; F16B 41/002

(57) ABSTRACT

A captive fastener is provided that holds a fastener in place prior to the fastener being driven into a surface. The captive fastener includes a ring-shaped base and at least one prong with a distal end. The captive fastener may include a ring-shaped fastener holder attached to the distal end of the at least one prong. The head of the fastener is secured to the distal end of the at least one prong or the ring-shaped fastener holder. As the fastener is driven into the surface, the at least one prong breaks away from the ring-shaped base. Alternatively the at least one prong bends as the fastener is driven into the surface.

### CROSS REFERENCE TO RELATED APPLICATION

This application claims the benefit of U.S. Provisional Application No. 62/760,533 for CAPTIVE FASTENER filed on Nov. 13, 2018, which is incorporated by reference as if fully set forth.

### FIELD OF INVENTION

The present invention relates generally to the art of construction, and more specifically to an apparatus that holds a fastener in position prior to being driven into a surface.

### BACKGROUND

When a fastener must be driven into a surface, such as a screw drilled into wood, the fastener must be located and held in place at the proper location by hand until the appropriate tool drives the fastener into the surface enough so that the surface itself holds the fastener. This task may be tedious and time consuming. Additionally, injury may result if the tool that drives the fastener into the surface hits the hand holding the fastener.

### SUMMARY

A captive fastener is provided comprising a ring-shaped base and at least one prong extending outward from the ring-shaped base. The at least one prong includes a distal end. The head of a fastener is secured by the distal end of the at least one prong. When the fastener is driven into a surface, the prongs of the captive fastener break away.

A captive fastener is also provided comprising a ring-shaped base, at least one prong with a distal end extending outward from the ring-shaped base, and a ring-shaped fastener holder attached to the distal end of the at least one prong. The head of a fastener is secured by the ring-shaped fastener holder. When the fastener is driven into the surface, the prong(s) of the captive fastener bend.

### BRIEF DESCRIPTION OF THE DRAWINGS

The foregoing summary, as well as the following detailed description will be better understood when read in conjunction with the appended drawings. For the purpose of illustration, there is shown in the drawings different embodiments. It should be understood, however, that the teachings are not limited to the precise captive fastener arrangements shown.

FIG. 1 is a front perspective view of a captive fastener.

FIG. 2 is a front view of the captive fastener.

FIG. 3 is a side view of the captive fastener.

FIG. 4 is a top view of the captive fastener.

FIG. 5 is a bottom view of the captive fastener.

FIG. 6 is a front perspective view of the captive fastener holding a fastener.

FIG. 7 is a front view of the captive fastener holding the fastener.

FIG. 8 is a side view of the captive fastener holding the fastener.

FIG. 9 is a top view of the captive fastener holding the fastener.

FIG. 10 is a bottom view of the captive fastener holding the fastener.

FIG. 11 is a front perspective view of prongs breaking off a ring-shaped base as the fastener is driven.

FIG. 12 is a front perspective view of the captive fastener after the fastener is driven.

FIG. 13 is a front perspective view of a second embodiment of a captive fastener holding a fastener.

FIG. 14 is a front perspective view of the second embodiment of the captive fastener.

FIG. 15 is a side view of the second embodiment of the captive fastener.

FIG. 16 is a top view of the second embodiment of the captive fastener.

FIG. 17 is a front view of the second embodiment of the captive fastener holding the fastener.

FIG. 18 is a top view of the second embodiment of the captive fastener holding the fastener.

FIG. 19 is a front perspective view of prongs bending as the fastener is being driven.

FIG. 20 is a front perspective view of the second embodiment of the captive fastener after the fastener is driven.

### DETAILED DESCRIPTION

A captive fastener that can hold a fastener in position prior to being driven into a surface is provided. The captive fastener includes a base that is connected to a surface at a location a fastener is designed to be driven into the surface. The captive fastener has at least one prong. The at least one prong may have a fastener seat or may be attached to a fastener holder. The fastener seat or the at least one holder holds a fastener in place prior to the fastener being driven into the surface. The apparatus prepares a fastener to be driven into a surface. The apparatus eliminates the step of holding a fastener in place by hand while using a tool to drive the fastener into the surface. Therefore, the apparatus saves time and prevents injury from holding the fastener by hand.

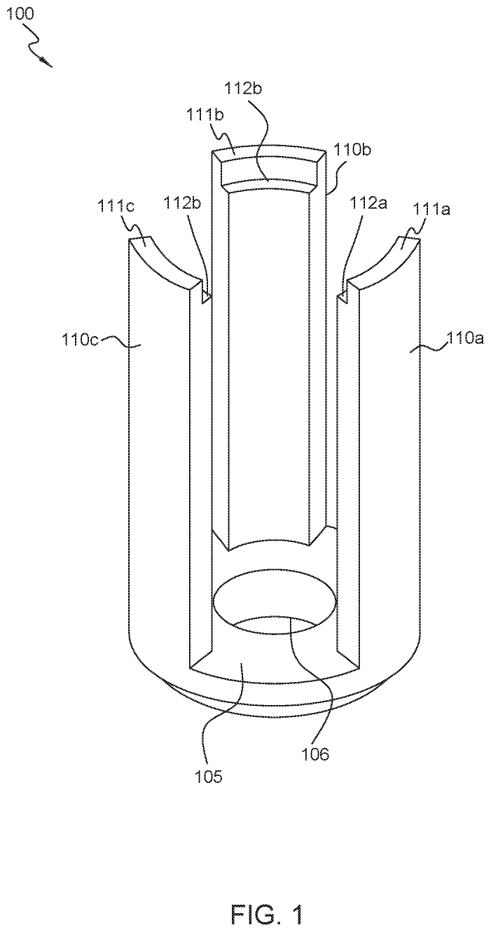

FIG. 1 is a front perspective view of a captive fastener 100. A captive fastener 100 is provided that holds a fastener 120 (not shown in FIG. 1 for clarity) in place prior to the fastener 120 being driven into a surface. The captive fastener 100 includes a ring-shaped base 105. Although the base 105 is ring-shaped in FIG. 1, the base 105 may be any shape with an opening 106 in the approximate center for the fastener 120. For example, the base may be square-shaped with an opening 106 for the fastener 120 in the center of the base 105. In use, the ring-shaped base 105 is attached to a surface at a location designed to receive a fastener 120. For example, the ring-shaped base 105 may be adhered to the surface of a wood board at a location where a screw must be drilled into the wood board. Additionally, the bottom of the ring-shaped base 105 may include an adhesive surface (not shown). The adhesive surface allows the captive fastener 100 to be quickly stuck to a surface. Alternatively, the bottom of the ring-shaped base 105 may include at least one pin (not shown). The at least one pin allows the captive fastener 100 to be pressed and stuck into a surface.

The captive fastener 100 includes at least one prong 110a-c extending outward from the ring-shaped base 105. The prongs 110a-c are attached to the base 105 at approximately 90 degrees. Alternatively the prongs 110a-c may be attached to the base 105 at an angle slightly more or less than 90 degrees. The captive fastener 100 may include a first prong 110a, a second prong 110b, and a third prong 110c as depicted in FIG. 1. Although FIG. 1 depicts three prongs 110a-c the captive fastener 100 may include fewer than three prongs 110a-c or more than three prongs 110a-c. Each prong 110a-c includes a distal end 111a-c. The distal end 111a-c of the prongs 110a-c may include a fastener seat 112a-c. The fastener seat 112a-c is configured to hold a head 122 of a fastener 120. The prongs 110a-c may be relatively rectangular in shape. The relatively rectangular prongs 110a-c may have a slight curve to correspond to the curve of the base 105.

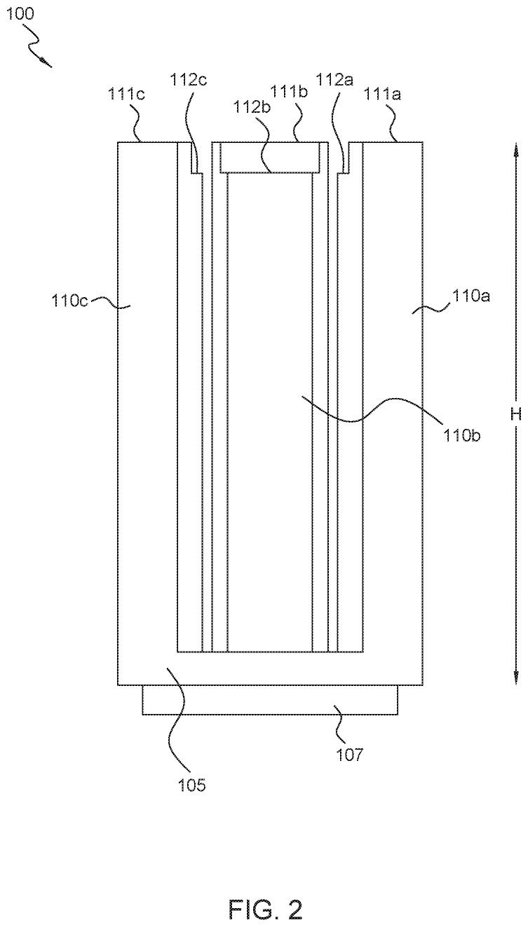

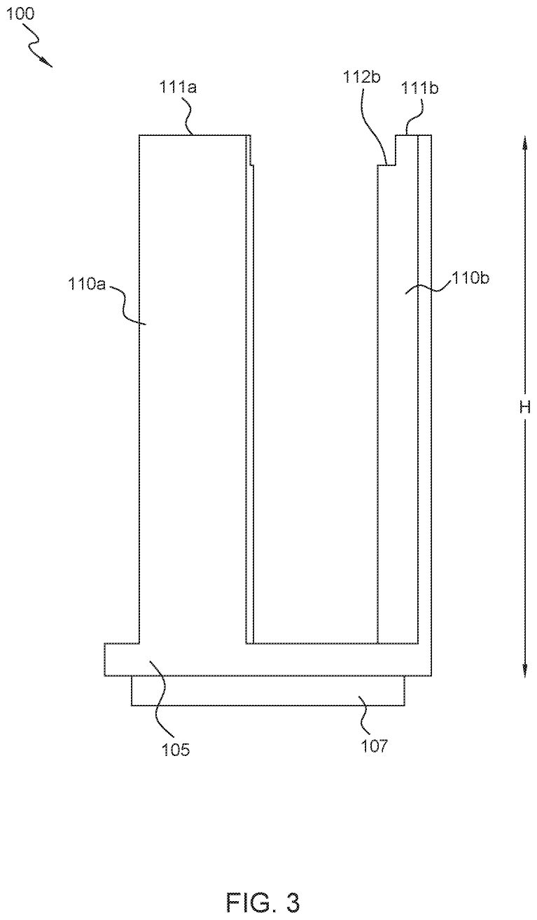

FIG. 2 is a front view of the captive fastener 100. FIG. 3 is a side view of the captive fastener 100. With reference to FIG. 2 and FIG. 3, the prongs 110a-c have a height H. The height H of each prong 110a-c is approximately the same. The height H is approximately the same as the length of a shank 124 of a fastener 120. The height permits the tip 126 of a fastener 120 to touch the surface the fastener 120 will be drilled into when the distal ends 111a-c of the prongs 110a-c are holding the head 122 of the fastener 120. The base 105 of the captive fastener 100 may include a protrusion 107. The protrusion 107 may include the means of connecting the captive fastener 100 to the surface. For example, the protrusion 107 may include the adhesive surface or at least one pin to connect the captive fastener 100 to the surface.

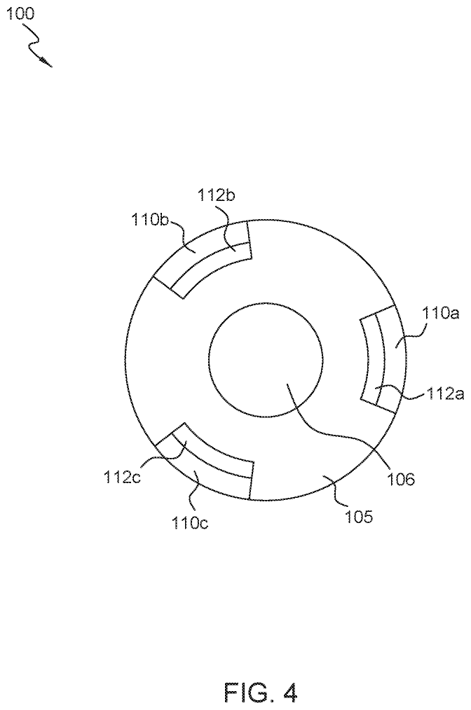

FIG. 4 is a top view of the captive fastener 100. The prongs 110a-c may be evenly spaced along the circumference of the base 105. For example, if there are three prongs 110, the first prong 110a, the second prong 110b, and the third prong 110c may be spaced approximately 120 degrees apart from the center of the captive fastener 100, as shown in FIG. 4. If there are four prongs 110, the prongs 110 may be spaced approximately 90 degrees apart from the center of the captive fastener 100. The prongs 110 may be evenly spaced to equally distribute the pressure on the head 122 of the fastener 120 and to center the fastener 120.

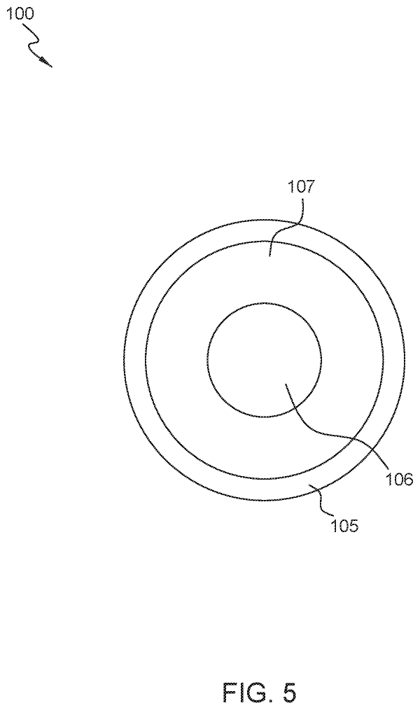

FIG. 5 is a bottom view of the captive fastener 100. The opening 106 in the base 105 of the captive fastener 100 is approximately centered. The diameter of the opening 106 is larger than the diameter of the shank 124 of a fastener 120. The opening 106 allows the fastener 120 to project through the captive fastener 100 and into the surface when the fastener 120 is driven.

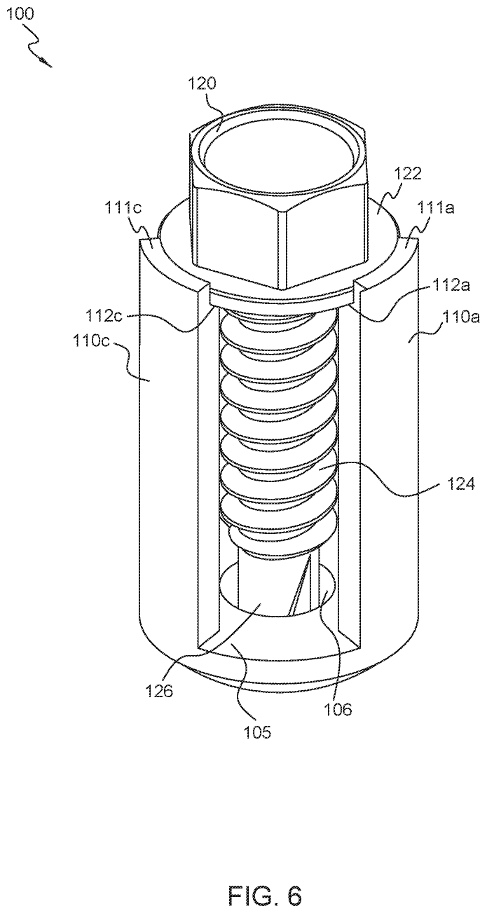

FIG. 6 is a front perspective view of the captive fastener 100 holding a fastener 120. The fastener 120 may be a screw, nail, bolt, etc. The distal ends 111a-c of the prongs 110a-c and the fastener seats 112a-c engage with the head 122 of the fastener 120 to secure the fastener 120 in place. As shown in FIG. 6, the fastener seats 112a-c are configured to hold the head 122 of the fastener 120 in place. The distal ends 111a-c of the prongs 110a-c provide a combined inward pressure on the head 122 of the fastener 120 to secure the fastener 120 in place. The shank 124 of the fastener 120 extends through the captive fastener 100. The end or tip of the fastener 120 is centered in the opening 106 in the base 105.

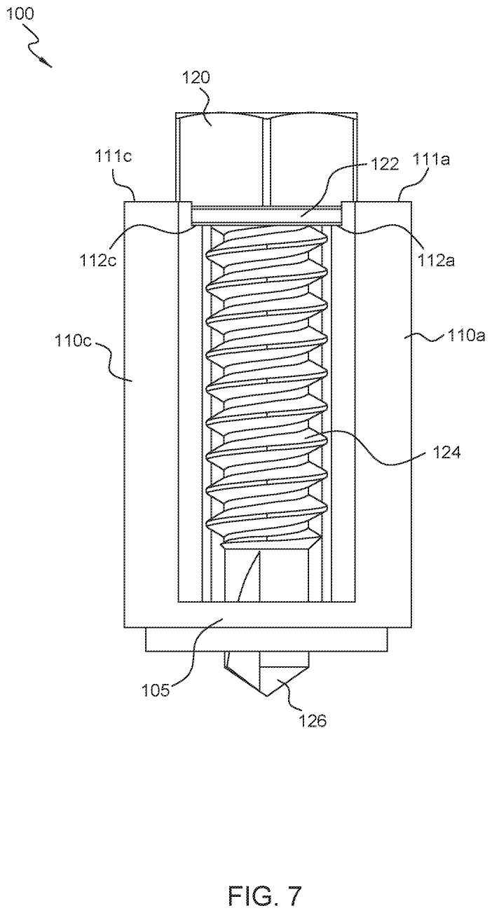

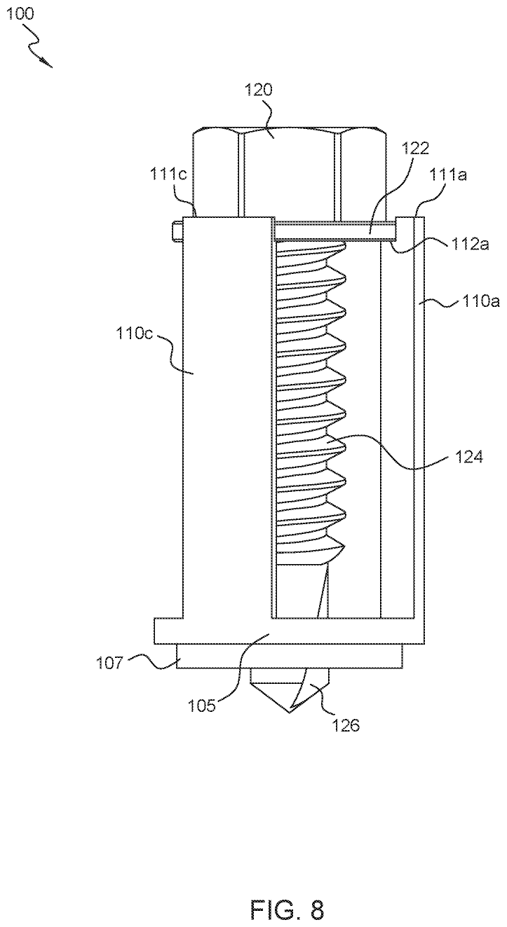

FIG. 7 is a front view of the captive fastener 100 holding the fastener 120. FIG. 8 is a side view of the captive fastener 100 holding the fastener 120. Referring to FIG. 7 and FIG. 8, the fastener seats 112a-c of the prongs 110a-c secure the fastener 120 by the head 122. The shank 124 of the fastener 120 extends from the head 122 of the fastener 120 to the surface the fastener 120 will be driven into. The end or tip 126 of the fastener 120 is adjacent with the bottom of the base 105 or protrusion 107. Alternatively the end or tip 126 may extend through the base 105 and/or protrusion 107.

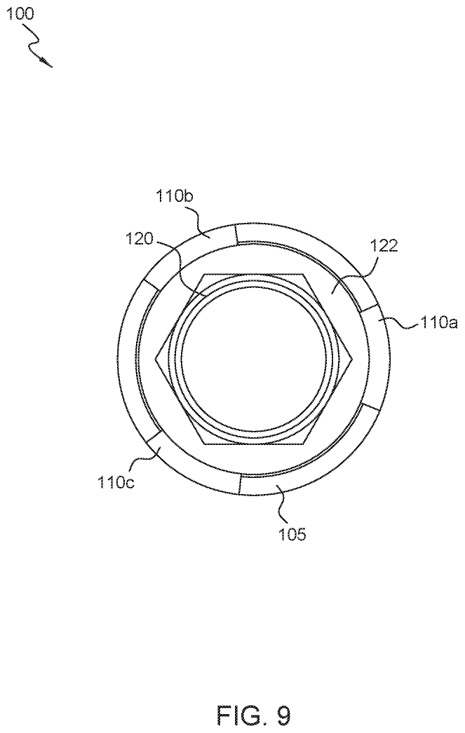

FIG. 9 is a top view of the captive fastener 100 holding the fastener 120. The prongs 110a-c are attached to the base 105 so that the spacing of the prongs 110a-c corresponds to the diameter of the head 122 of the fastener 120. The spacing of the prongs 110a-c may be slightly less than the diameter of the head 122 of the fastener 120 so that the prongs 110a-c are pushed outward and provide a resisting force on the head 122 of the fastener 120 thereby clamping the head 122 of the fastener 120.

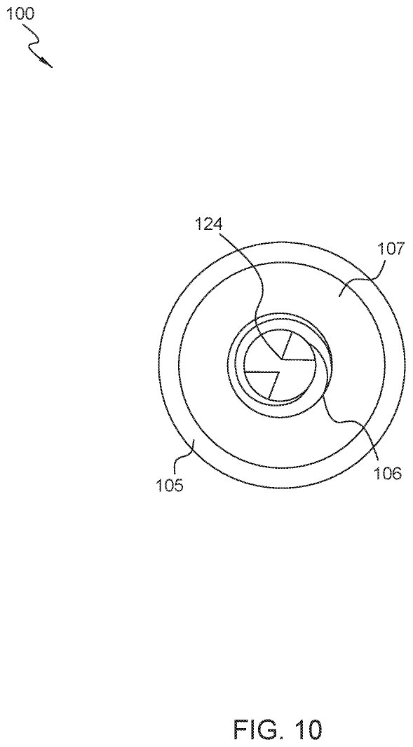

FIG. 10 is a bottom view of the captive fastener 100 holding the fastener 120. The shank 124 of the fastener 120 is centered in the opening 106 of the base 105. The diameter of the opening 106 may match or be slightly larger than the diameter of the shank 124.

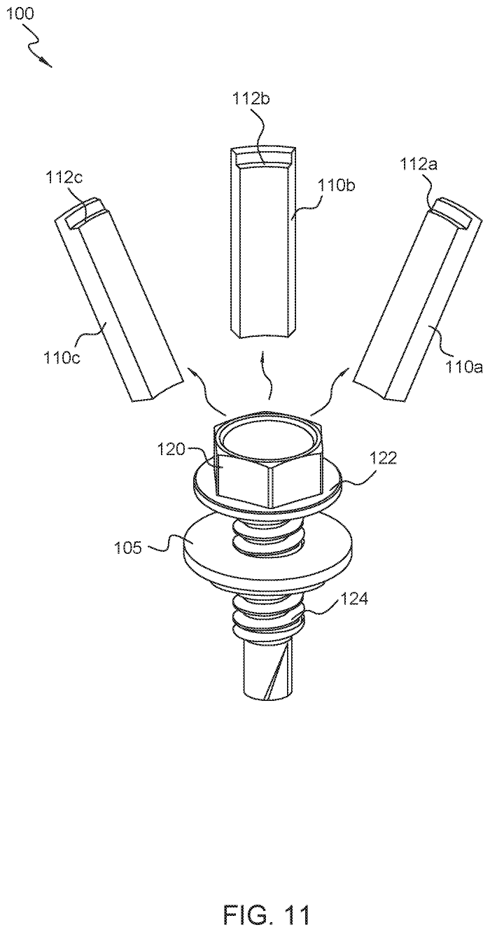

FIG. 11 is a front perspective view of prongs 110a-c breaking off a ring-shaped base 105 as the fastener 120 is driven. In operation, as the fastener 120 is being driven into a surface, the head 122 of the fastener 120 is forced past the fastener seats 112a-b. The head 122 of the fastener 120 pushes the prongs 110a-c radially outward until the head 122 of the fastener 120 forces the prongs 110a-c to break away and disconnect from the ring-shaped base 105. The arrows in FIG. 11 represent the prongs 110a-c breaking away from the base 105 as the fastener 120 is driven. Once the fastener 120 is driven into the surface, only the ring-shaped base 105 remains. The fastener 120 may be driven into the surface with any appropriate tool such as a screw driver, hammer, wrench, drill etc. The captive fastener 100 may be made from a polymer (ABS, PE, PS, etc.) or any other material that is rigid and has physical geometries that facilitate the prongs to break away when the fastener 120 is driven. The material must be sufficiently rigid to support the fastener and sufficiently brittle to allow the prongs 110a-c to break away when the fastener 120 is driven into the surface.

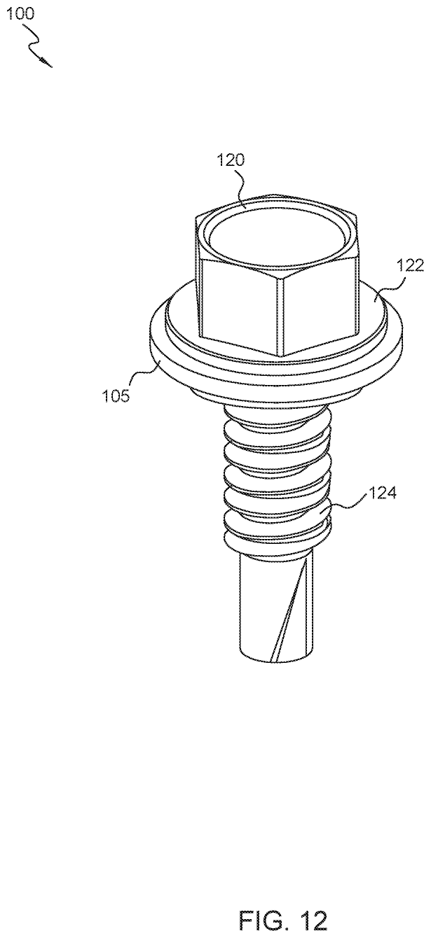

FIG. 12 is a front perspective view of the captive fastener 100 after the fastener 120 is driven into a surface. The base 105 remains after the prongs 110a-c break away. The base 105 may act as a washer to the fastener 120. The remaining base 105 may serve as a stress mitigation by spreading the screw load and as a retention device. Alternatively the base 105 and the opening 106 in the base 105 (not visible in FIG. 12) may have a diameter that is greater than the head 122 of the fastener 120. If the opening 106 has a greater diameter than the head 122 of the fastener 120, the base 105 may be removed after the fastener 120 is driven into the surface.

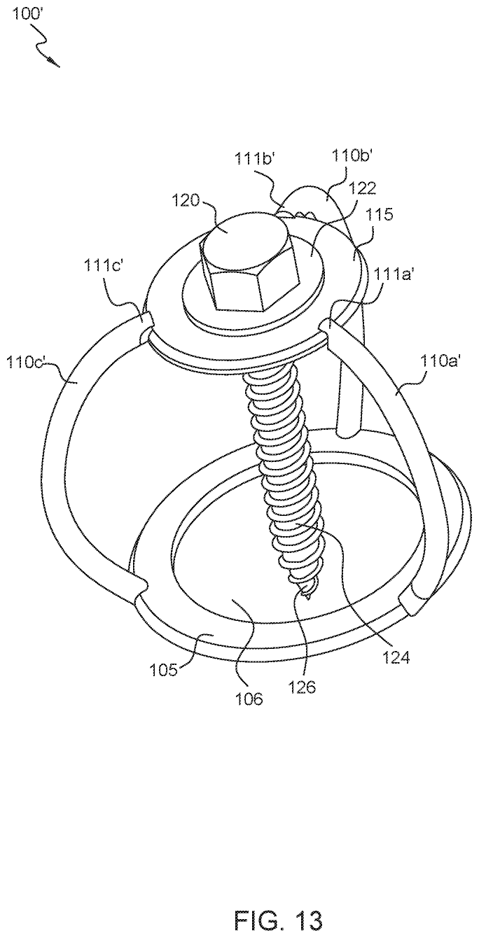

FIG. 13 is a front perspective view of a second embodiment of a captive fastener 100′ holding a fastener 120. The captive fastener 100′ includes a ring shaped base 105 and at least one prong 110a′-c′ attached to the ring-shaped based 105. A ring-shaped fastener holder 115 is attached to the distal ends 111a′-c′ of the prongs 110a′-c′. The fastener 120 may be a screw, nail, bolt, etc.

Although the base 105 is ring-shaped in FIG. 13, the base 105 may be any shape with an opening 106 in the approximate center for the fastener 120. For example, the base 105 may be square-shaped with an opening 106 for the fastener 120 in the center of the base 105. In use, the ring-shaped base 105 is attached to a surface at a location designed to receive a fastener 120. For example, the ring-shaped base 105 may be adhered to the surface of a wood board at a location where a screw must be drilled into the wood board. Additionally, the bottom of the ring-shaped base 105 may include an adhesive surface (not shown). The adhesive surface allows the captive fastener 100′ to be quickly stuck to a surface. Alternatively, the bottom of the ring-shaped base 105 may include at least one pin (not shown). The at least one pin allows the captive fastener 100′ to be pressed and stuck into a surface.

The captive fastener 100′ includes at least one prong 110a′-c′ extending outward from the ring-shaped base 105. The prongs 110a′-c′ may be curved to promote bending of the prongs 110a′-c′. The captive fastener 100′ may include a first prong 110a′, a second prong 110b′, and a third prong 110c′ as depicted in FIG. 13. Although FIG. 13 depicts three prongs 110a′-c′ the captive fastener 100′ may include fewer than three prongs 110a′-c′ or more than three prongs 110a′-c′. Each prong 110a′-c′ includes a distal end 111a′-c′. The distal end 111a′-c′ of the prongs 110a′-c′ are attached to a ring-shaped fastener holder 115.

The ring-shaped fastener holder 115 engages with the head 122 of the fastener 120. The diameter of the ring-shaped fastener holder 115 corresponds to the diameter of the head 122 of the fastener 120. The head 122 of the fastener 120 is secured in the ring-shaped fastener holder 115 through a press-fit connection.

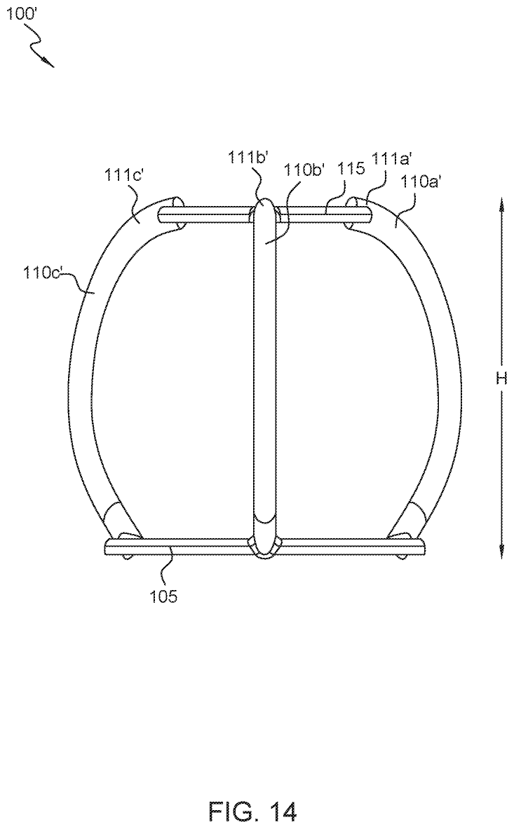

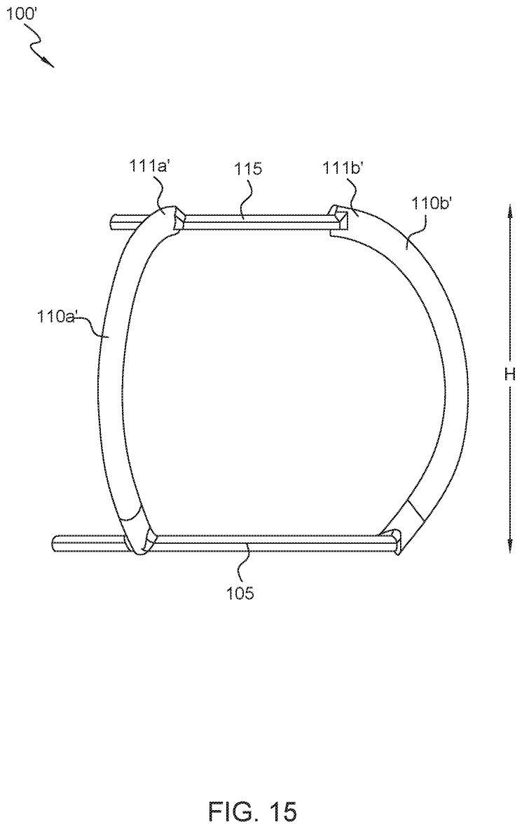

FIG. 14 is a front perspective view of the second embodiment of the captive fastener 100′. FIG. 15 is a side view of the second embodiment of the captive fastener 100′. With reference to FIG. 14 and FIG. 15, the prongs 110a′-c′ have a height H. The height H of each prong 110a′-c′ is approximately the same. The height H is approximately the same as the length of a shank 124 of the fastener 120. The height permits the tip 126 of a fastener 120 to touch the surface the fastener 120 will be drilled into when the ring-shaped fastener holder 115 is holding the head 122 of the fastener 120.

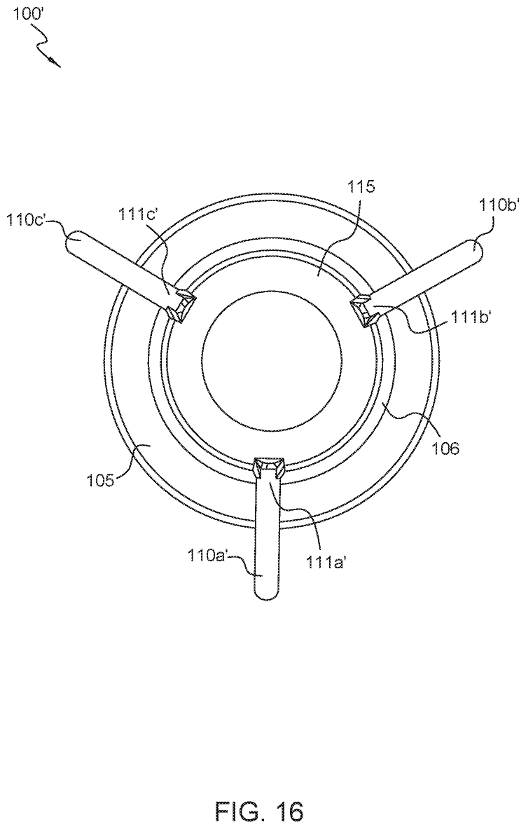

FIG. 16 is a top view of the second embodiment of the captive fastener 100′. The prongs 110a′-c′ may be evenly spaced along the circumference of the base 105. For example, if there are three prongs 110′, the first prong 110a′, the second prong 110b′, and the third prong 110c′ may be spaced approximately 120 degrees apart from the center of the captive fastener 100′, as shown in FIG. 16. If there are four prongs 110′, the prongs 110′ may be spaced approximately 90 degrees apart from the center of the captive fastener 100′. The prongs 110′ may be evenly spaced to center the fastener 120.

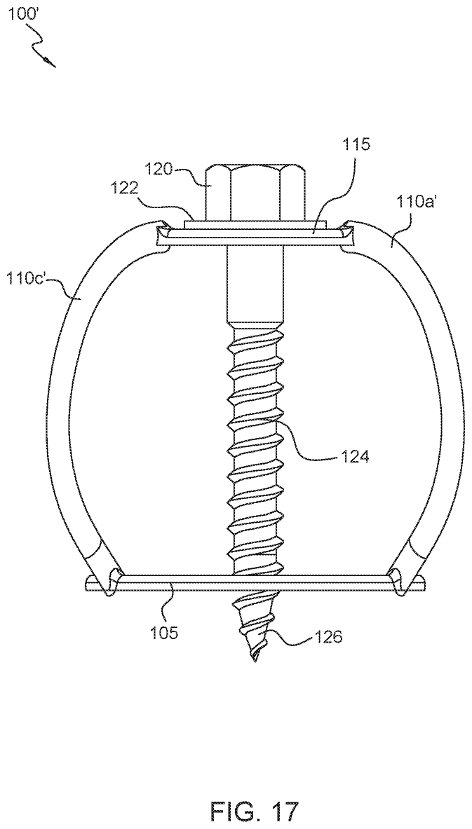

FIG. 17 is a front view of the second embodiment of the captive fastener 100′ holding the fastener 120. The ring-shaped fastener holder 115 secures the fastener 120 by the head 122. The shank 124 of the fastener 120 extends from the head 122 of the fastener 120 to the surface the fastener 120 will be driven into. The end or tip 126 of the fastener 120 is adjacent with the bottom of the base 105. Alternatively the end or tip 126 may extend through the base 105.

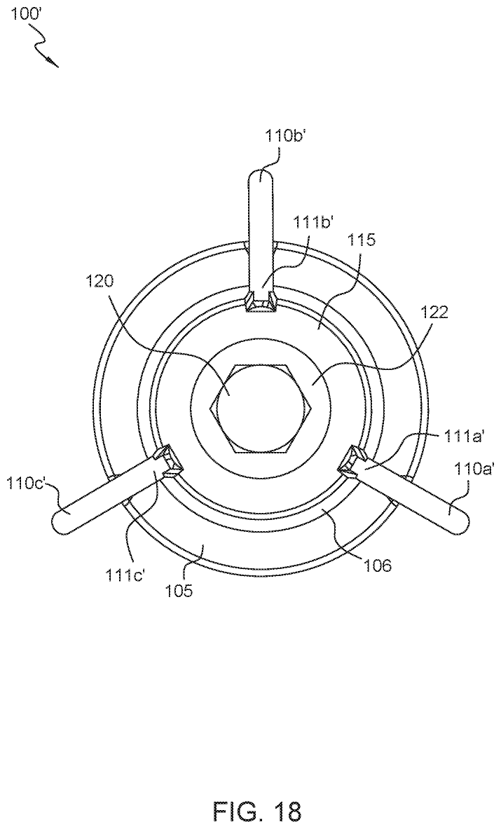

FIG. 18 is a top view of the second embodiment of the captive fastener 100′ holding the fastener 120. The prongs 110a′-c′ center the ring-shaped fastener holder 115 and the fastener 120. The diameter of the opening 106 in the base 105 may be larger than the diameter of the ring-shaped fastener holder 115 to allow the head 122 of the fastener 120 to be flush with the surface after the fastener 120 is driven into the surface.

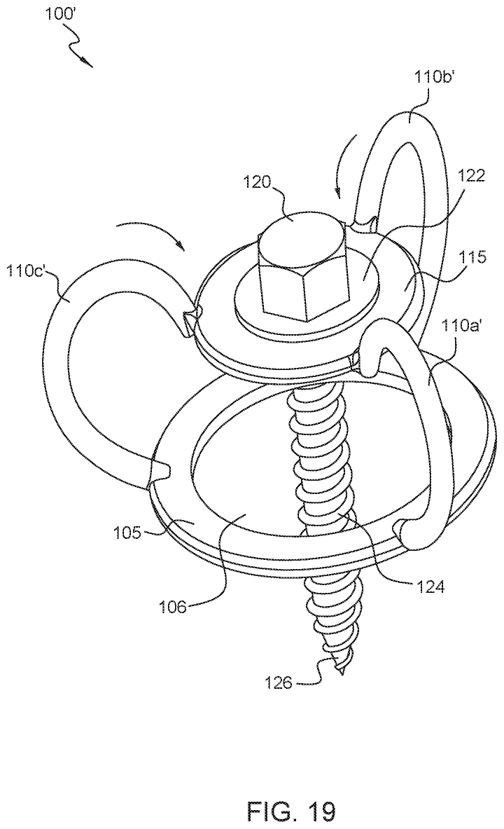

FIG. 19 is a front perspective view of the prongs 110a′-c′ bending as the fastener 120 is being driven. FIG. 19 shows the captive fastener 100′ during use. In operation, as the fastener 120 is being driven into a surface, the head 122 of the fastener 120 is driven down toward the surface. The press-fit connection between the head 122 of the fastener 120 and the ring-shaped fastener holder 115 forces the ring-shaped fastener holder 115 down towards the surface with the head 122 of the fastener 120. As the head 122 of the fastener 120 and the ring-shaped fastener holder 115 are forced downward, the prongs 110a′-c′ bend. The arrows in FIG. 19 represent the prongs 110a′-c′ bending as the fastener 120 is driven. The fastener 120 may be driven into the surface with any appropriate tool such as a screw driver, hammer, wrench, drill, etc. The captive fastener 100′ may be made from may be made from a polymer (ABS, PE, PS, etc.) or any other material that allows the prongs to deform without breaking. The material must be sufficiently strong to support the fastener 120 and sufficiently elastic to allow the prongs 110a′-c′ to bend and deform without breaking when the fastener 120 is driven into the surface.

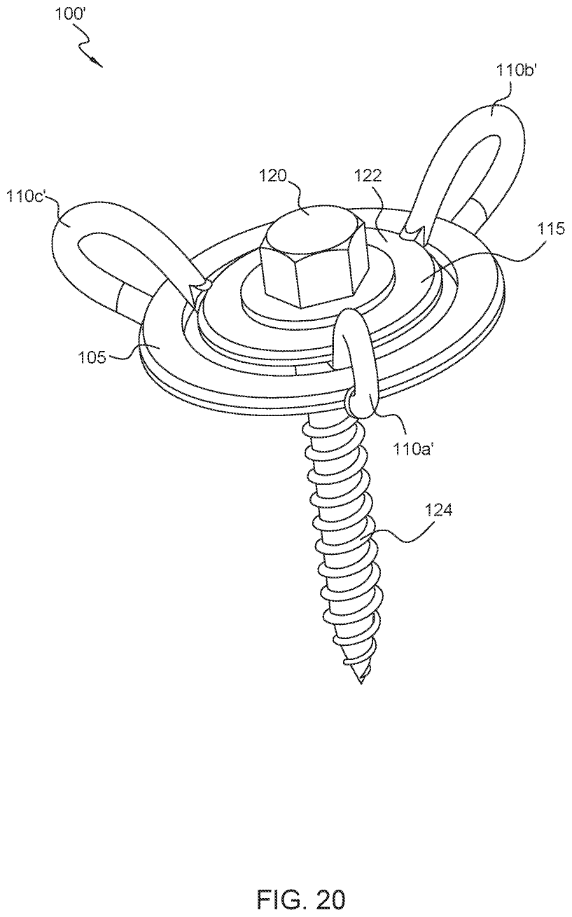

FIG. 20 is a front perspective view of the second embodiment of the captive fastener 100′ after the fastener 120 is driven. The fastener 120 in FIG. 20 is driven into a surface. The ring-shaped fastener holder 115 is adjacent with the base 105. The prongs 110a′-c′ are bent substantially in half. The entire captive fastener 100′ may remain after the fastener 120 is driven into the surface. Alternatively, the captive fastener 100′ may be pried from the head 122 of the fastener 120 and removed.

Having thus described in detail a preferred selection of embodiments of the present invention, it is to be appreciated and will be apparent to those skilled in the art that many physical changes could be made to the captive fastener 100, 100′ without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A captive fastener comprising:
a base including an opening; and
at least one prong extending outward from the base;
wherein the at least one prong includes a distal end.

2. The captive fastener of claim 1 further comprising a second prong extending outward from the base.

3. The captive fastener of claim 2 further comprising a third prong extending outward from the base.

4. The captive fastener of claim 1 wherein the distal end includes a fastener seat.

5. The captive fastener of claim 1 further comprising a fastener.

6. The captive fastener of claim 5 wherein a head of the fastener is secured by the distal end of the at least one prong.

7. The captive fastener of claim 5 wherein the fastener is driven into a surface.

8. The captive fastener of claim 7 wherein the at least one prong is configured to break away from the base when the fastener is driven into the surface.

9. A captive fastener comprising:
a base including an opening;
at least one prong extending outward from the base and including a distal end; and
a ring-shaped fastener holder attached to the distal end.

10. The captive fastener of claim 9 further comprising a second prong extending outward from the base.

11. The captive fastener of claim 10 further comprising a third prong extending outward from the base.

12. The captive fastener of claim 9 further comprising a fastener.

13. The captive fastener of claim 12 wherein a head of the fastener is secured by the ring-shaped fastener holder.

14. The captive fastener of claim 9 wherein the fastener is driven into a surface.

15. The captive fastener of claim 14 wherein the at least one prong is configured to bend when the fastener is driven into the surface.
